(19) United States
(12) Patent Application Publication
(10) Pub. No.: US 2015/0014977 A1
(43) Pub. Date: Jan. 15, 2015

(54) COMPOSITION BOOK AND PLANNER

(71) Applicant: Leela Ivie Joshi, Brooklyn, NY (US)

(72) Inventor: Leela Ivie Joshi, Brooklyn, NY (US)

(21) Appl. No.: 13/940,298

(22) Filed: Jul. 12, 2013

(51) Int. Cl. B42D 1/00; B42D 3/12; B42D 15/00

(52) U.S. Cl. CPC B42D 1/001; B42D 15/0006; B42D 3/12
USPC 281/16

(57) ABSTRACT

The present invention relates in general to a paper-based composition book, and/or planner comprising a plurality of sections comprising a plurality of pages, separated by a continuous binding, wherein the binding enables one, or more than one section to be

### FIELD OF THE INVENTION

The present invention relates in general to a paper-based composition book, and/or planner comprising a plurality of sections comprising a plurality of pages, separated by a continuous binding, wherein the binding enables one, or more than one section to be displayed or accessed by a user simultaneously.

### BACKGROUND

People are increasingly employing a multitasking mindset to accomplish their day-to-day tasks and goals. Their planners and composition books should reflect and support this way of thinking to make multitasking easier to organize and support.

People are required to manage many pieces of information such as appointments, classes, meetings, errands, projects, responsibilities, thoughts, and ideas in the course of a typical day. In addition, a person has goals and other personal matters that need to be incorporated into the planning of their day in order for those matters to be realized. Because all of these various daily thought processes tend to overlap it is useful to be able to separate those thoughts and activities into individual sections for purposes of organization while still being able to access them simultaneously.

For this reason, it is useful for an individual to have access to more than one section of their composition book or planner at the same time. Examples of this would be looking at a calendar while writing a to-do list, sketching out ideas while referencing a journal entry, referencing notes from one class while writing notes for another class, and keeping a creative thoughts and sketches section open while simultaneously maintaining a pragmatic to-do list section.

A number of planners (also called daily organizers or personal organizers) and composition books (also called journals or notebooks) are available which provide specific places to write down notes, goals, appointments, to-do lists, and the like. The effectiveness of a planner and composition book depends upon its ease of use and the user's ability to write down the needed information in such a manner that allows it to be accessed efficiently and simultaneously in an organized manner.

Some paper-based planners use individual sheets of paper held in ring binders which can result in the loss of pages and therefore loss of vital information. Although the format of a binder allows the user to select various topics for recording information, a traditional binder cannot display, nor may a user access more than one section of information simultaneously. Nor will a traditional binder allow the user to easily alter the configuration in which more than one section is simultaneously displayed or accessed.

Similarly, some paper-based planners and composition books use individual sheets that tear out of bound books. Although the design of a perforated tear out page allows the user to access more than one page or section of information simultaneously, it does not allow for the pages to be put back in order or reattached, which can result in a loss of pages and page order and therefore loss of vital information.

Similarly, bound books with non perforated tear out pages require the user to sort through old and unneeded information and only allow the user to store and/or view information in a linear manner, i.e., the user cannot easily access pages that are not bound on the same facing page before or after it. There remains a need for a paper-based composition book and planner that permits the user to store information in an organized fashion while providing quick access to different types or sections of information individually or simultaneously.

### SUMMARY

The present invention addresses the above-described need by providing a paper-based composition book and/or planner comprising a plurality of sections comprising a plurality of pages, separated by a continuous binding, wherein the binding enables one, or more than one section to be displayed or accessed by a user simultaneously.

The plurality of sections comprising a plurality of pages, are separated from each other by a continuous binding, wherein the paper-based composition book or planner has a first outer cover hingedly connected to a plurality of inner covers that are located between the plurality of sections, via spines, and finally to a second outer cover.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 panel (a) shows one embodiment of the paper-based composition book or planner of the present invention comprising a first outer cover, having a first edge, a second edge, a third edge, and a fourth edge, wherein the first outer cover is hingedly connected to a first spine along the third edge of the of the first inner cover; a first inner cover, having a first edge, a second edge, a third edge, and a fourth edge, wherein the first inner cover is hingedly connected to the first spine along the third edge of the first inner cover, wherein a first section comprising a plurality of pages is located between the first outer cover and the first inner cover, and wherein the first inner cover is hingedly connected to a second spine along the first edge of the first inner cover; a second inner cover, having a first edge, a second edge, a third edge, and a fourth edge, wherein the second inner cover is hingedly connected to the second spine along the first edge of the second inner cover, and wherein the second inner cover is hingedly connected to a third spine along the second edge of the second inner cover; and a second outer cover, having a first edge, a second edge, a third edge, and a fourth edge, wherein the second outer cover is hingedly connected to the third spine along the second edge of the second outer cover, and wherein a second section comprising a plurality of pages is located between the second outer cover and the second inner cover. FIG. 1 panel (b) shows the paper-based composition book or planner displayed in panel (a) open along the third spine. FIG. 1 panel (c) shows the paper-based composition book or planner displayed in panel (a) open along the first spine.

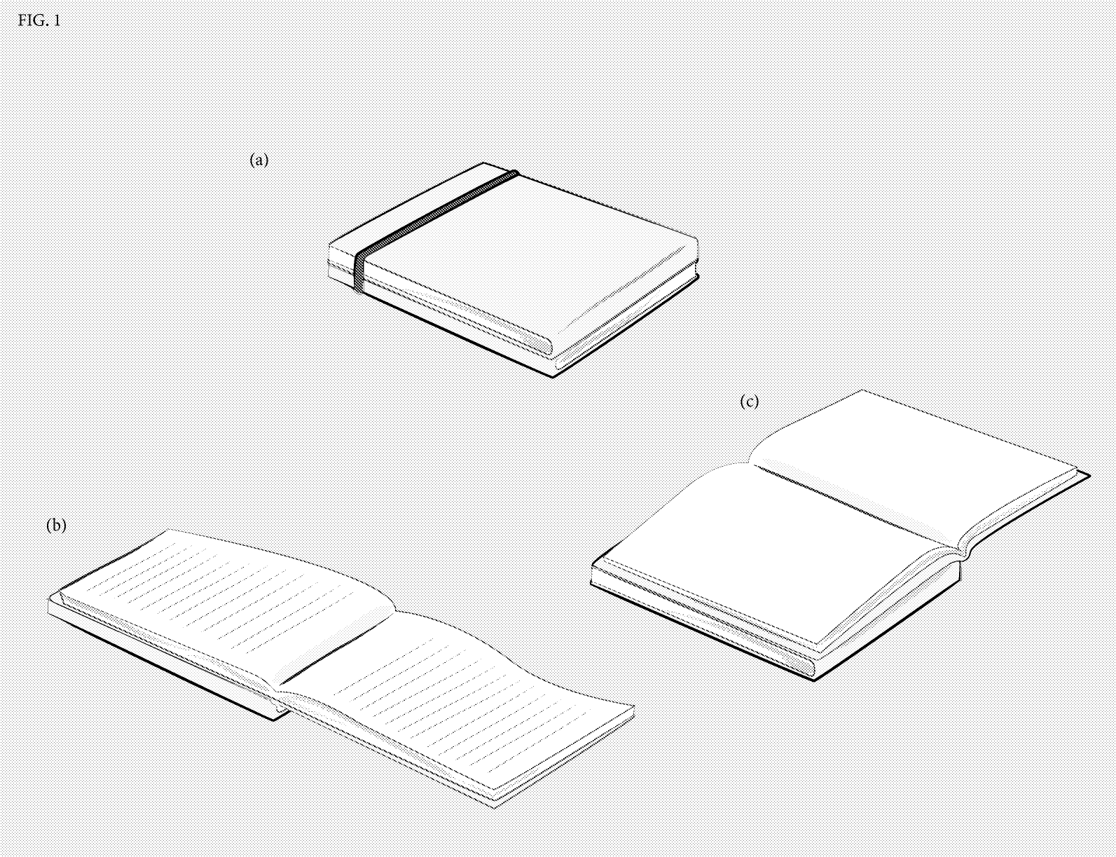

FIG. 2 panel (a) shows the paper-based composition book or planner displayed in FIG. 1 panel (a) open along the first, second and third spines. FIG. 2 panel (b) shows the paper-based composition book or planner displayed in FIG. 1 panel (a) open along the second spine. FIG. 2 panel (c) shows another view of the paper-based composition book or planner displayed in FIG. 1 panel (a) open along the second spine.

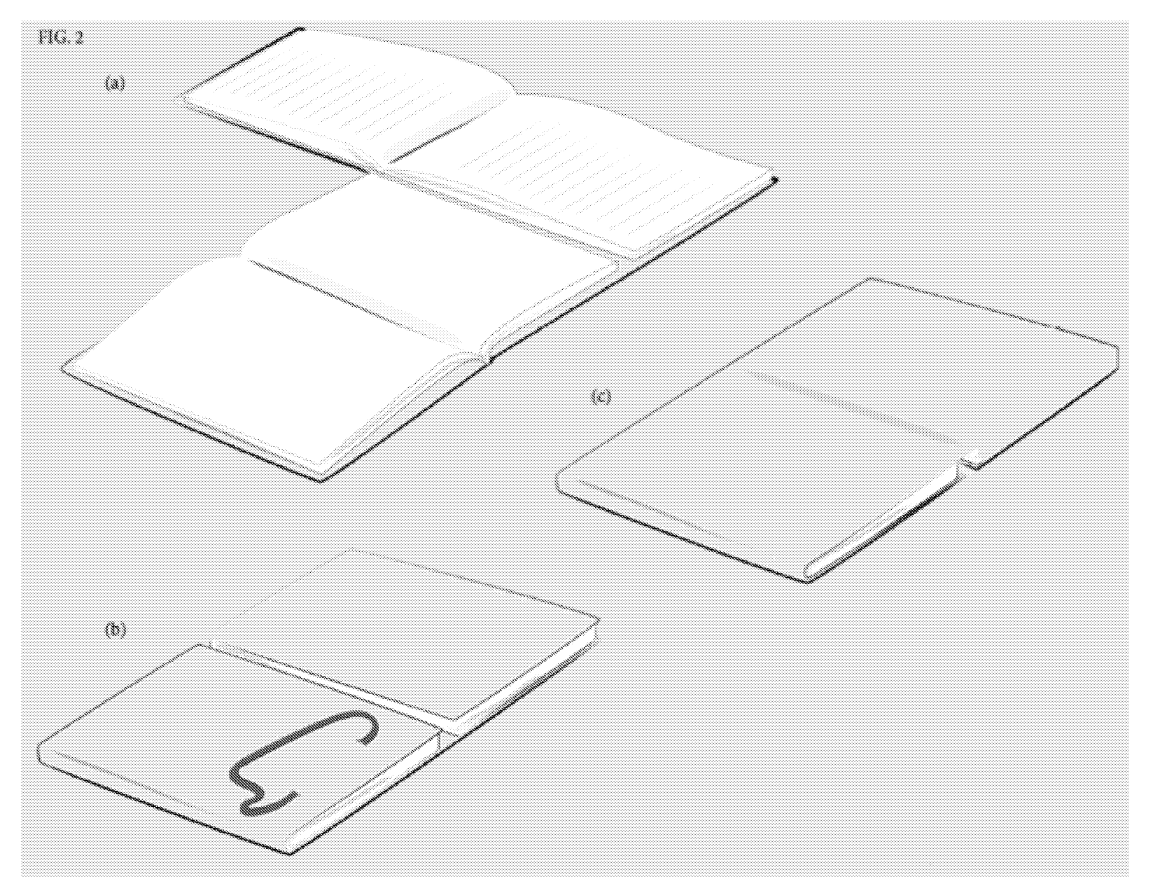

FIG. 3 shows another embodiment of the paper-based composition book or planner of the present invention comprising a first outer cover, having a first edge, a second edge, a third edge, and a fourth edge, wherein the first outer cover is hingedly connected to a first spine along the first edge of the first outer cover; a first inner cover, having a first edge, a second edge, a third edge, and a fourth edge, wherein the first inner cover is hingedly connected to the first spine along the first edge of the first inner cover, and wherein a first section comprising a plurality of pages is located between the first outer cover and the first inner cover, and wherein the first inner cover is hingedly connected to a second spine along the second edge of the first inner cover; a second inner cover, having a first edge, a second edge, a third edge, and a fourth edge, wherein the second inner cover is hingedly connected to the second spine along the second edge of the second inner cover, and wherein a second section comprising a plurality of pages is located between the first inner cover and the second inner cover, and wherein the second inner cover is hingedly connected to a third spine along the fourth edge of the second inner cover; a third inner cover, having a first edge, a second edge, a third edge, and a fourth edge, wherein the third inner cover is hingedly connected to the third spine along the fourth edge of the third inner cover, and wherein a third section comprising a plurality of pages is located between the second inner cover and the third inner cover, and wherein the third inner cover is hingedly connected to a fourth spine along the third edge of the third inner cover; and a second outer cover, having a first edge, a second edge, a third edge, and a fourth edge, wherein the second cover is hingedly connected to the fourth spine along the third edge of the third inner cover, and wherein a fourth section comprising a plurality of pages is located between the third inner cover and the second outer cover.

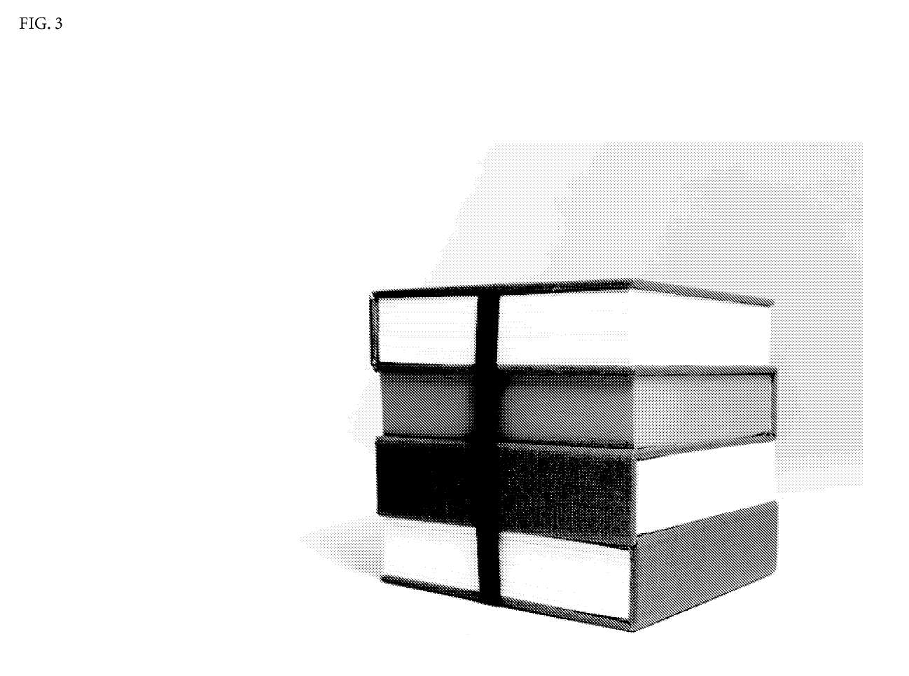

FIG. 4 shows the paper-based composition book or planner displayed in FIG. 3 opened at the first, second, third and fourth spines.

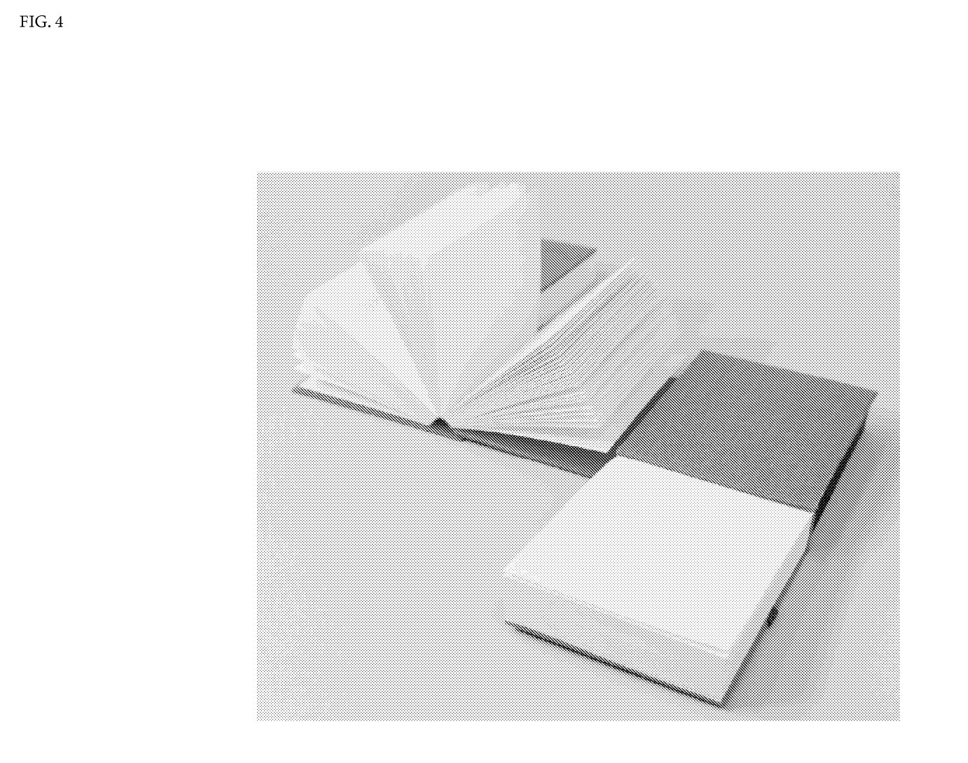

FIG. 5 is an alternate perspective view of one embodiment of the paper-based composition book or planner of the present invention.

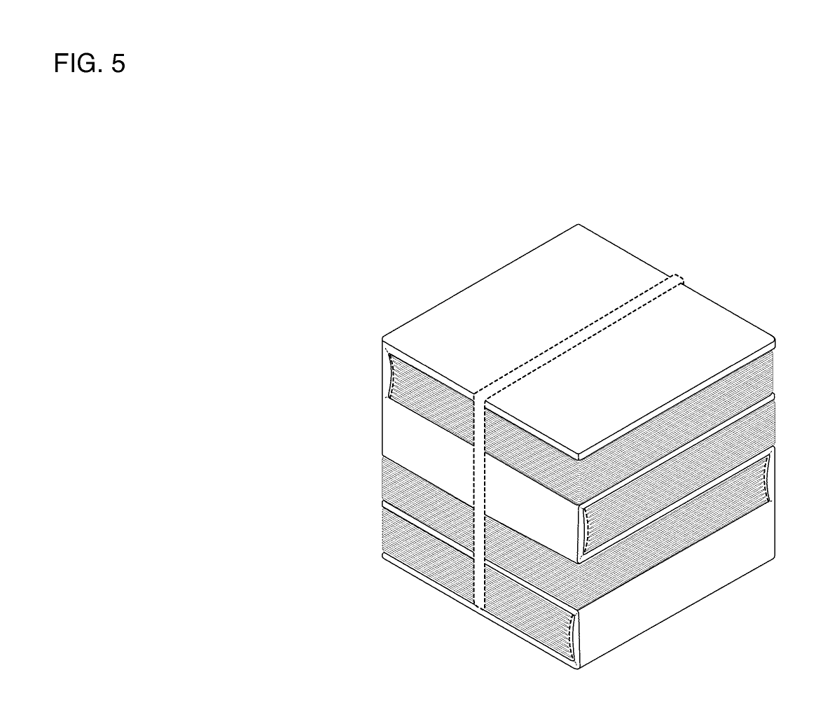

FIG. 6 is a front view of one embodiment of the paper-based composition book or planner of the present invention.

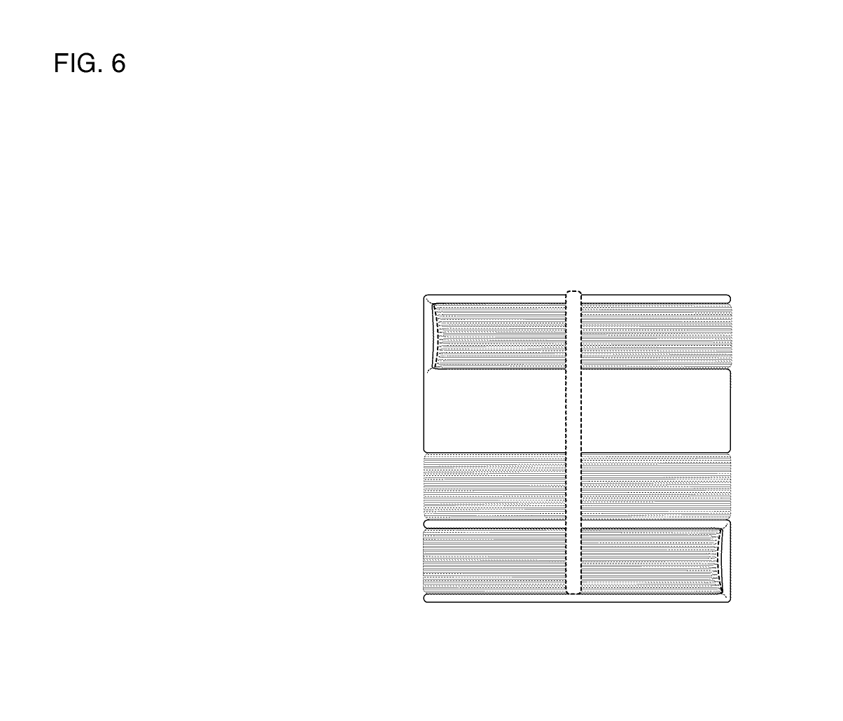

FIG. 7 is a rear view of one embodiment of the paper-based composition book or planner of the present invention.

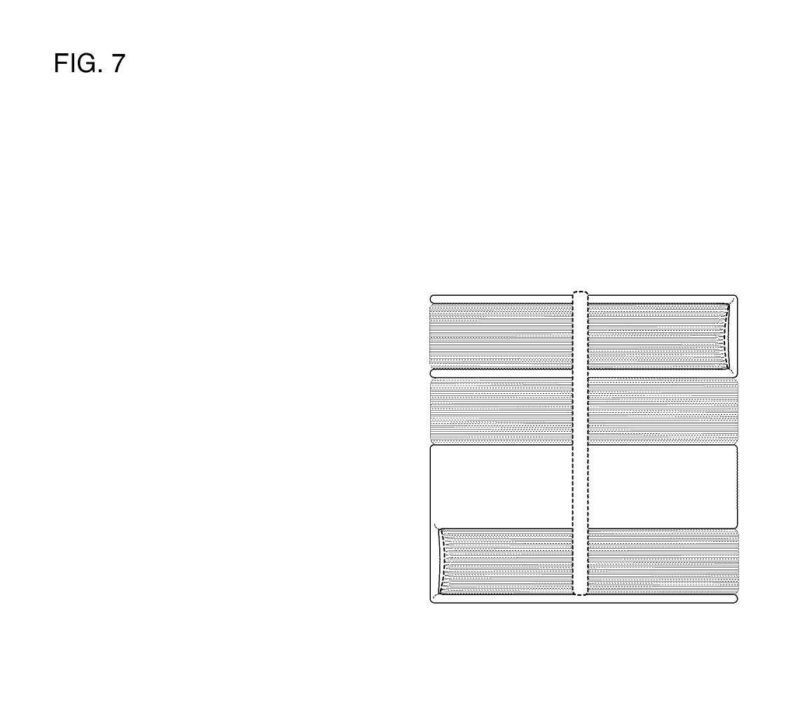

FIG. 8 is a left-side view of one embodiment of the paper-based composition book or planner of the present invention.

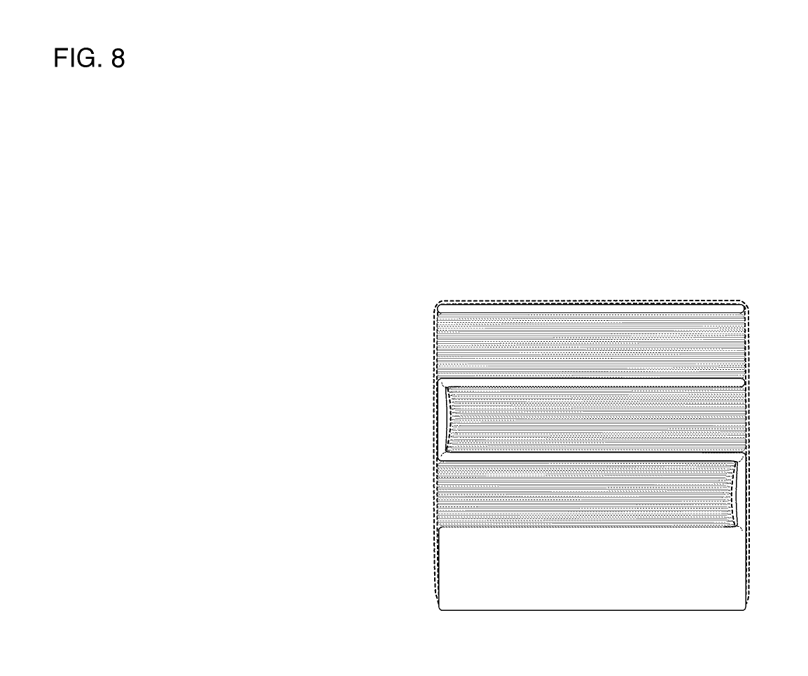

FIG. 9 is a right-side view of one embodiment of the paper-based composition book or planner of the present invention.

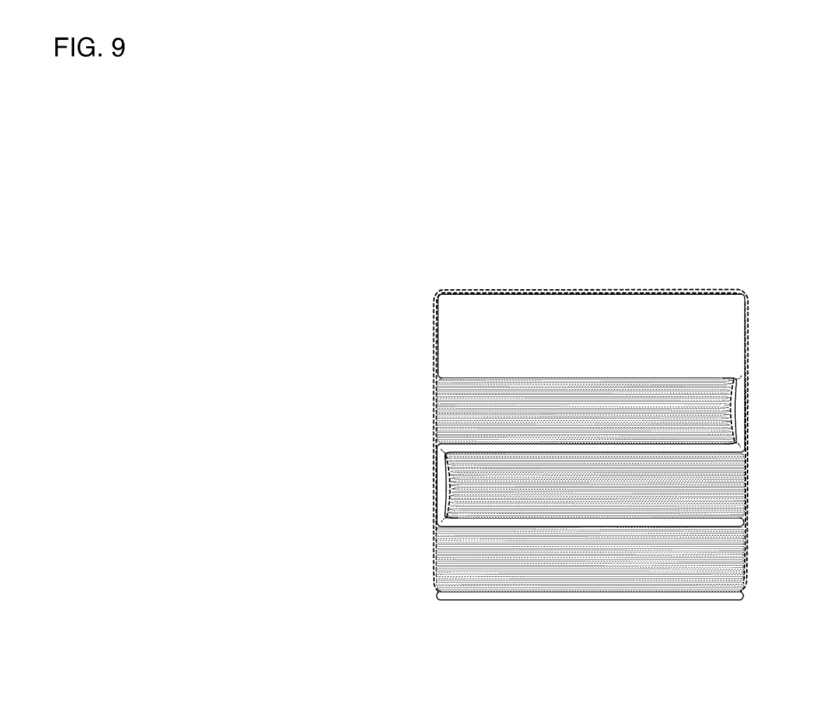

FIG. 10 is a top view of one embodiment of the paper-based composition book or planner of the present invention.

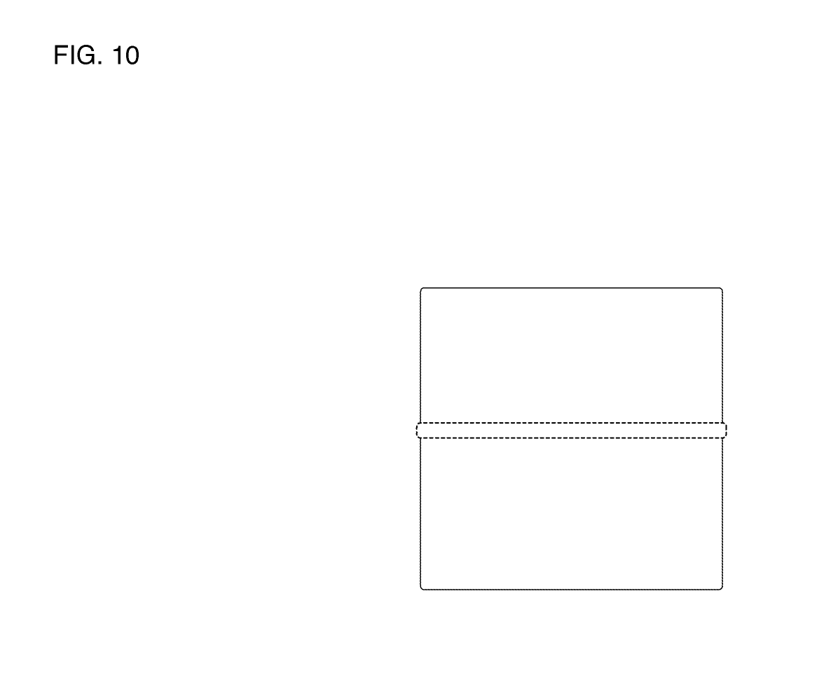

FIG. 11 is a bottom view of one embodiment of the paper-based composition book or planner of the present invention.

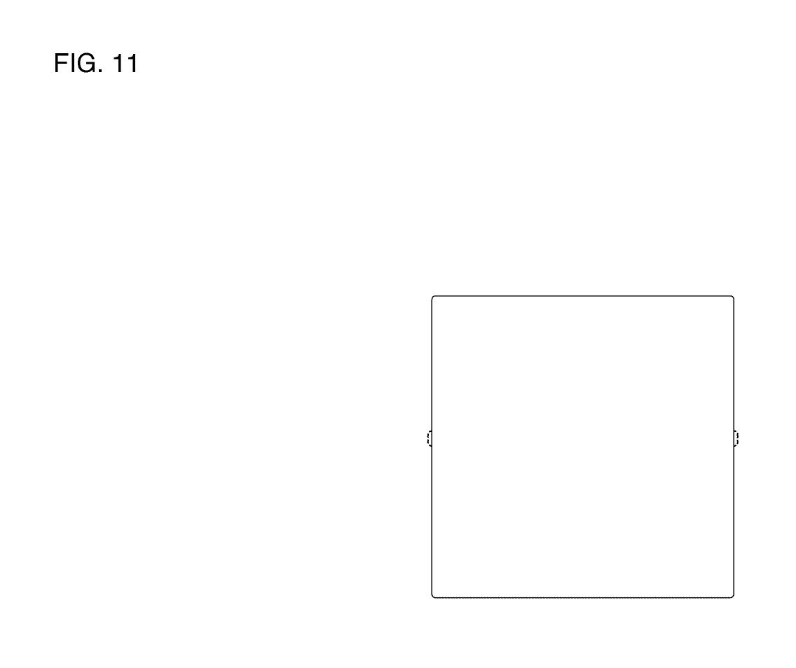

FIG. 12 is a perspective view of one embodiment of the paper-based composition book or planner of the present invention, showing one possible way to open the composition book or planner.

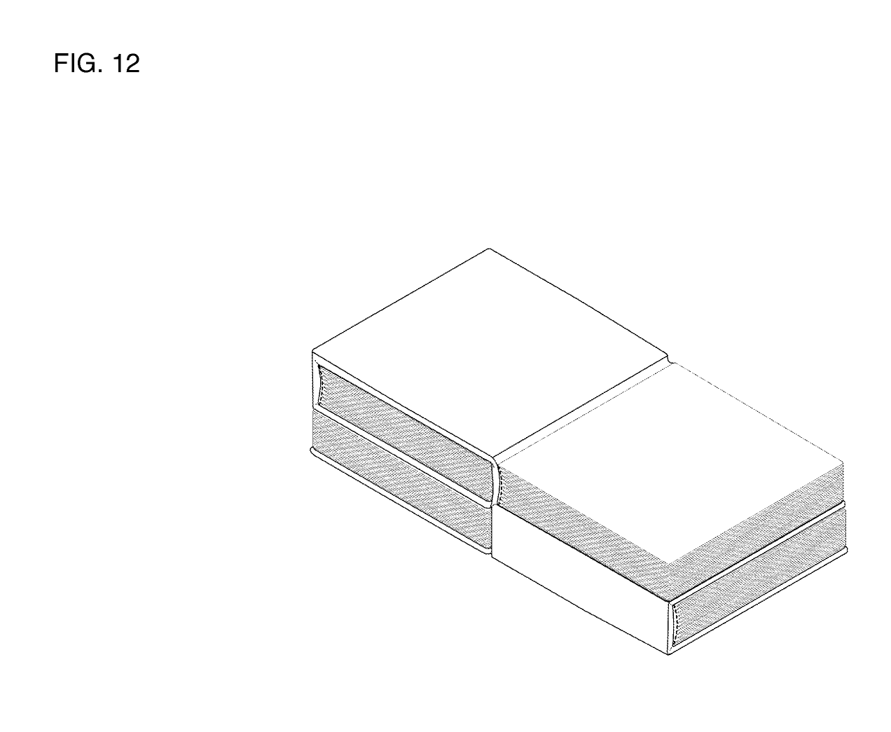

FIG. 13 is an alternate perspective view of one embodiment of the paper-based composition book or planner of the present invention, showing another possible way to open the composition book or planner.

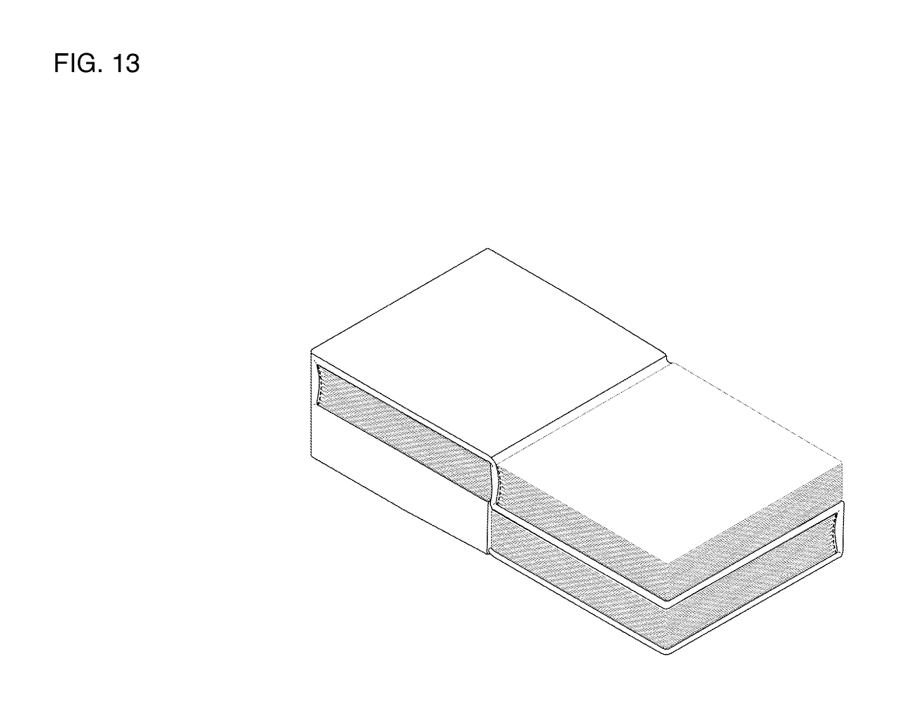

FIG. 14 is an alternate perspective view of one embodiment of the paper-based composition book or planner of the present invention, showing another possible way to open the composition book or planner.

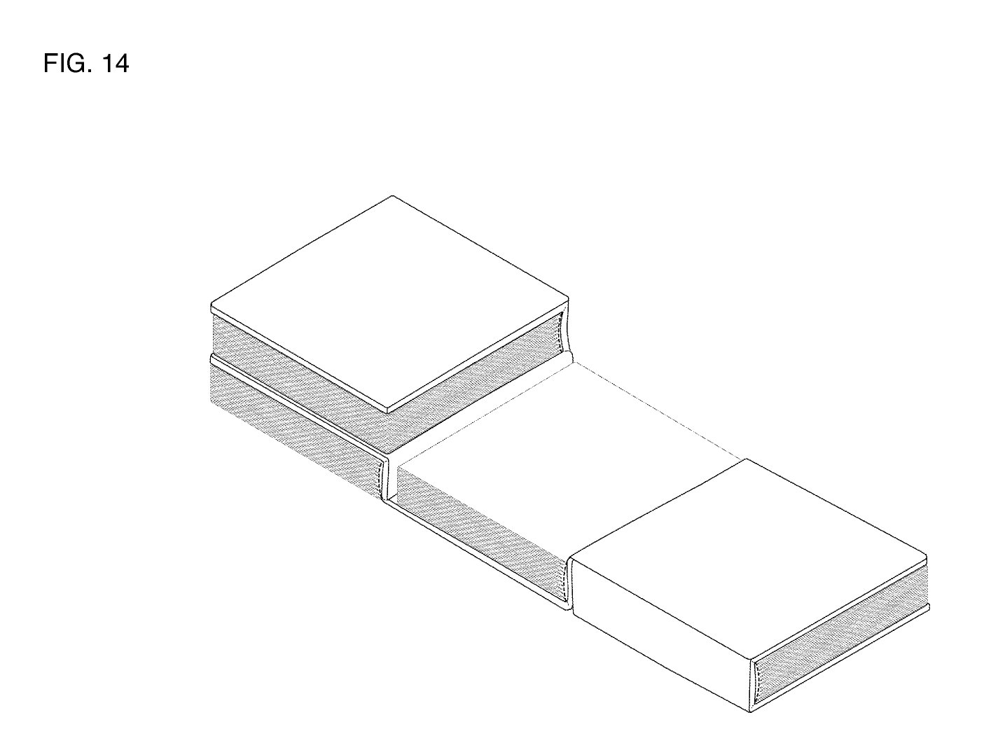

FIG. 15 is an alternate perspective view of one embodiment of the paper-based composition book or planner of the present invention, showing another possible way to open the composition book or planner.

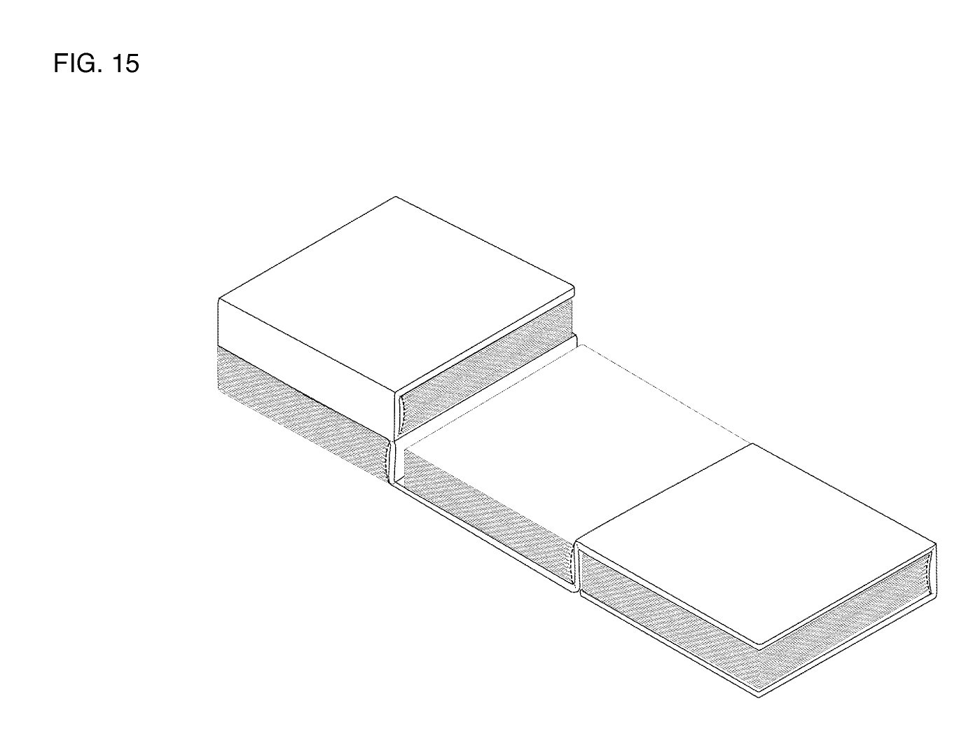

FIG. 16 is an alternate perspective view of one embodiment of the paper-based composition book or planner of the present invention, showing another possible way to open the composition book or planner.

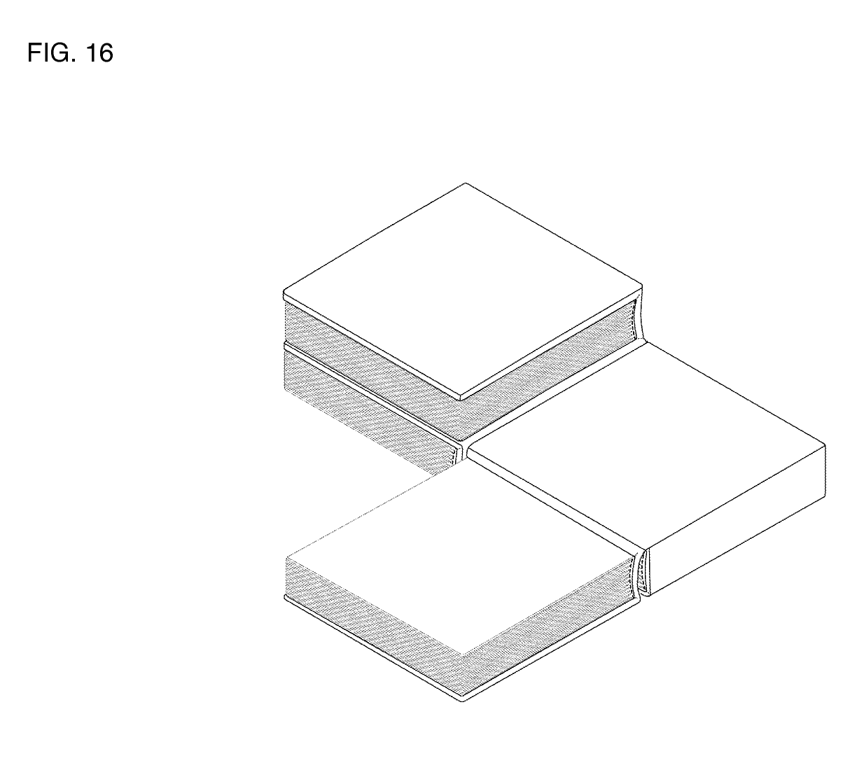

FIG. 17 is an alternate perspective view of one embodiment of the paper-based composition book or planner of the present invention, showing another possible way to open the composition book or planner.

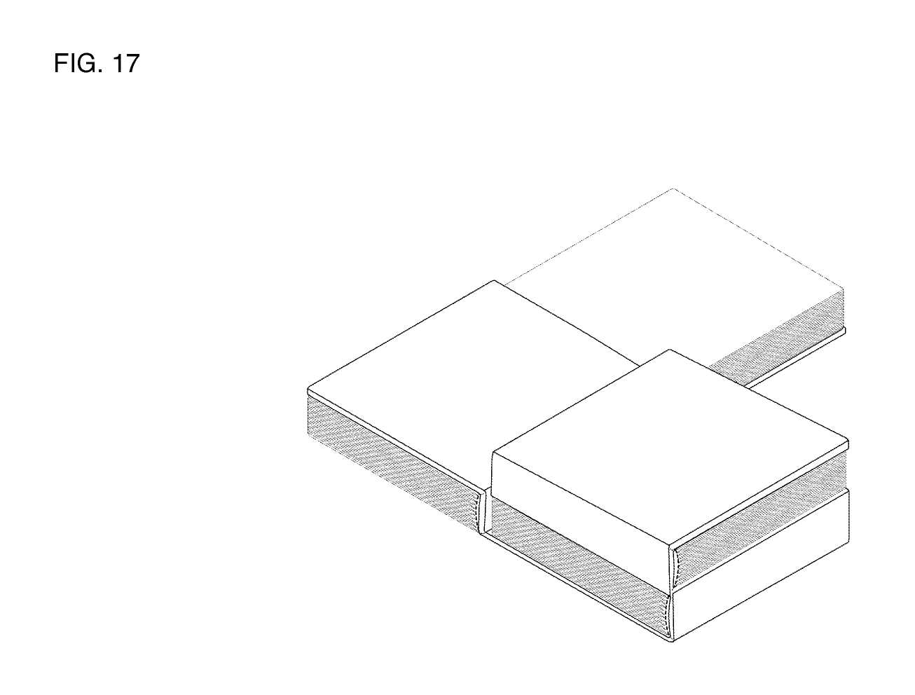

FIG. 18 is an alternate perspective view of one embodiment of the paper-based composition book or planner of the present invention, showing another possible way to open the composition book or planner.

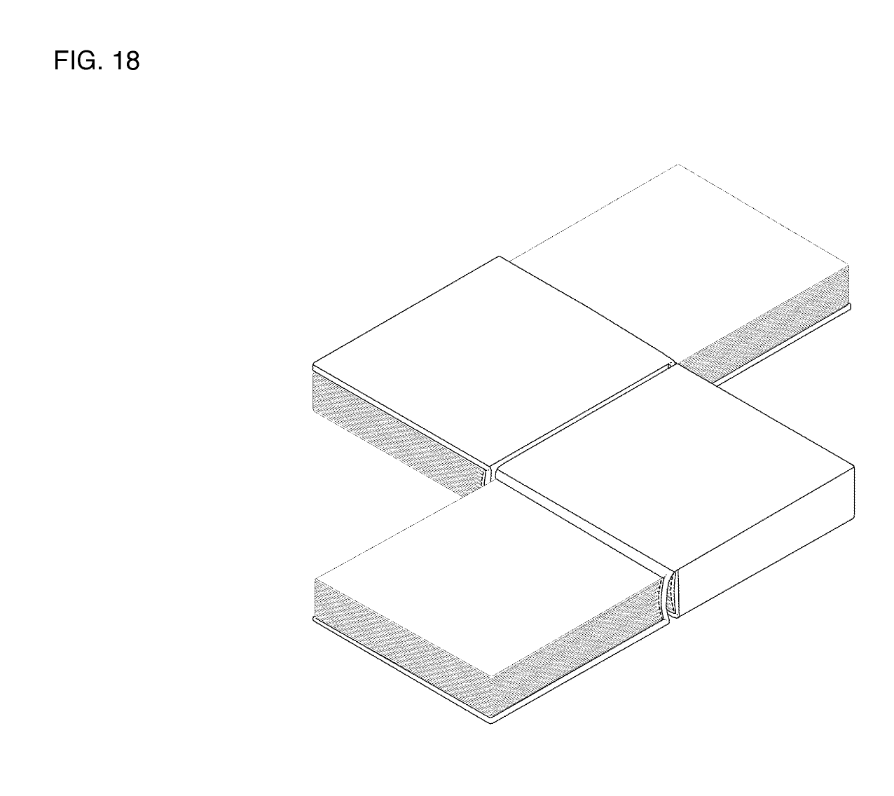

FIG. 19 is an alternate perspective view of one embodiment of the paper-based composition book or planner of the present invention, showing another possible way to open the composition book or planner.

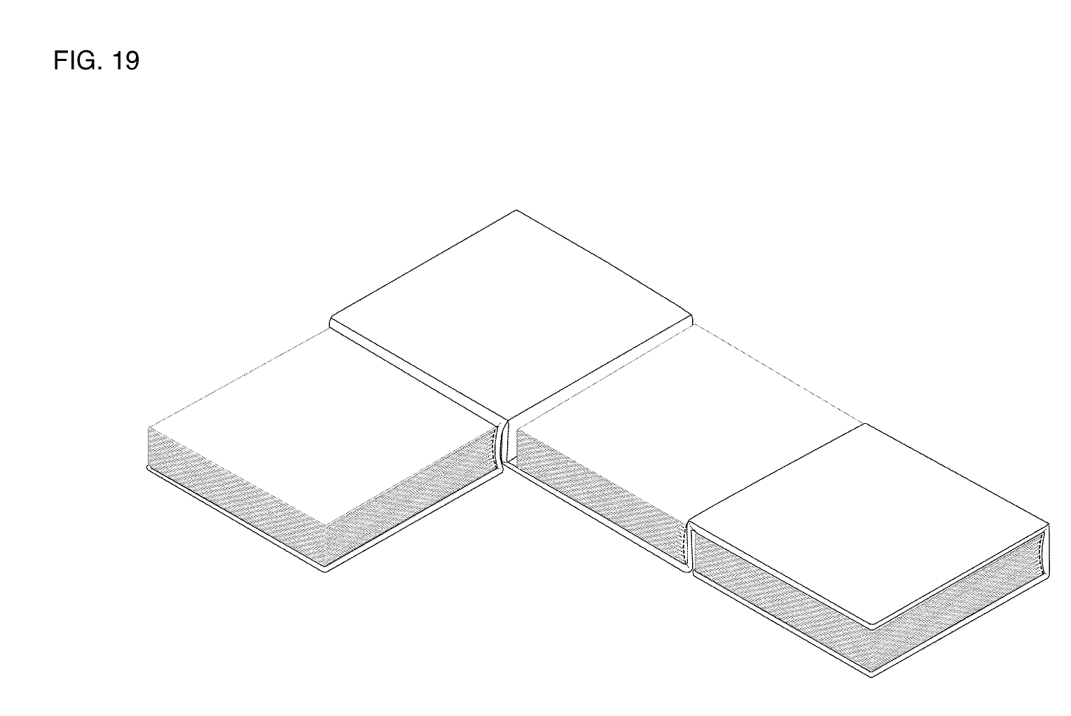

FIG. 20 is an alternate perspective view of one embodiment of the paper-based composition book or planner of the present invention, showing another possible way to open the composition book or planner.

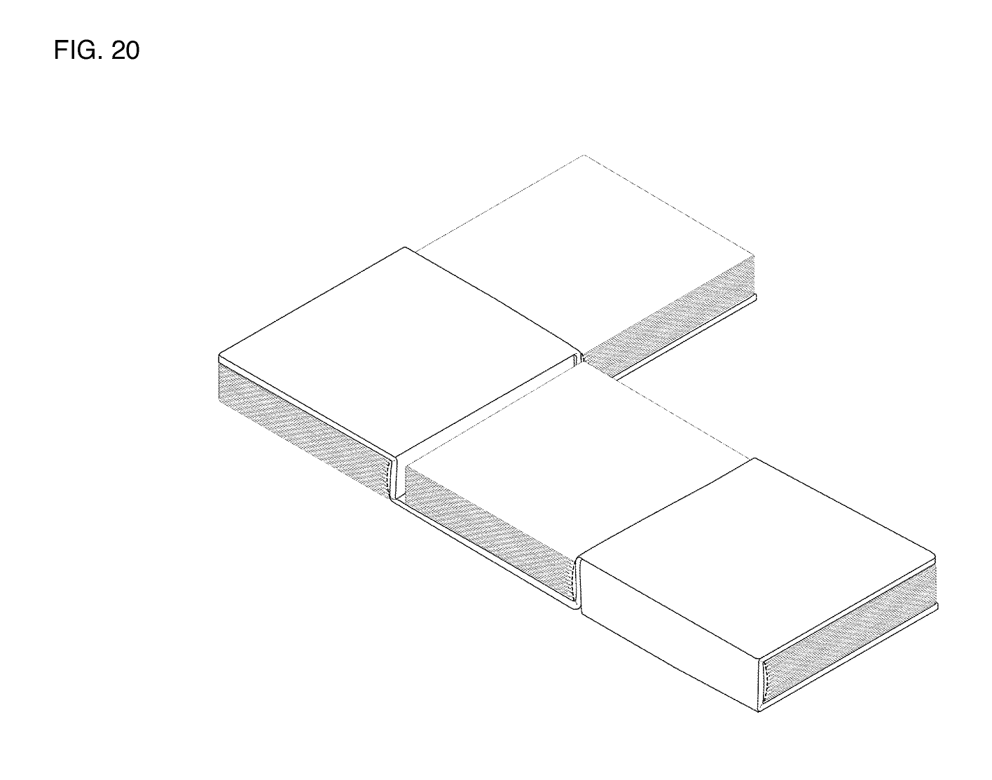

FIG. 21 is an alternate perspective view of one embodiment of the paper-based composition book or planner of the present invention, showing another possible way to open the composition book or planner.

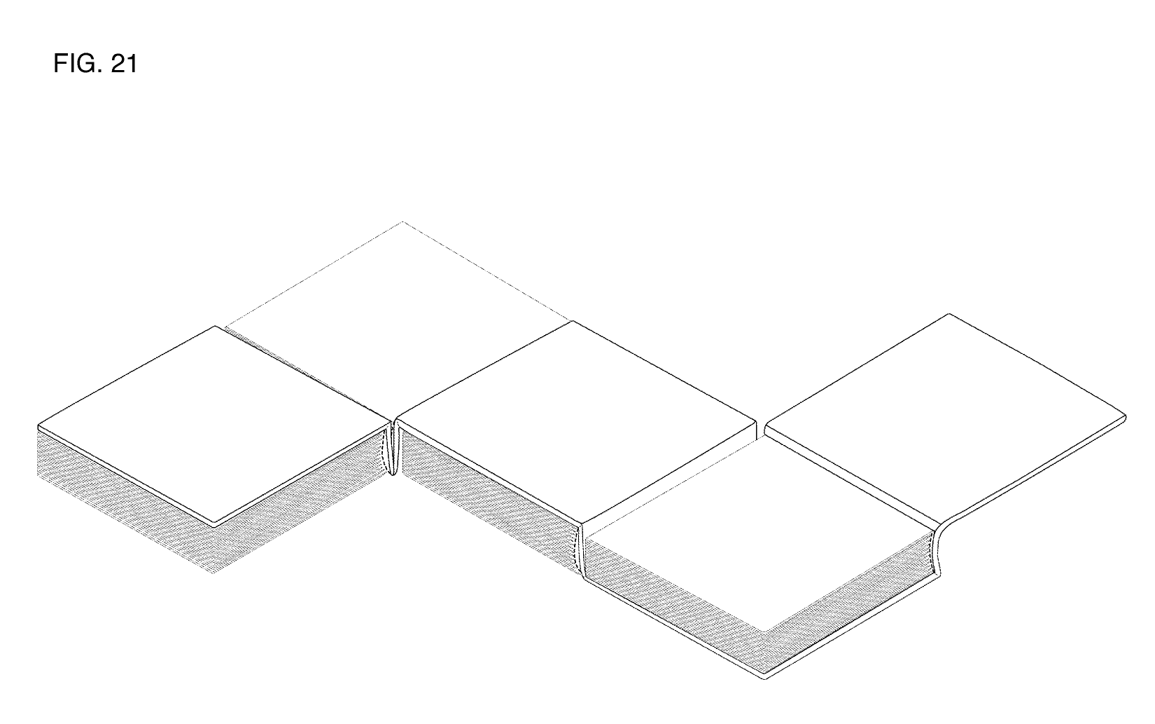

### DETAILED DESCRIPTION

In one embodiment, the present invention provides to a paper-based composition book or planner comprising a plurality of sections comprising a plurality of pages, separated by a continuous binding, wherein the binding enables one, or more than one section to be displayed or accessed by a user.

In one embodiment, the paper-based composition book or planner of the present invention has two sections. In an alternate embodiment, the paper-based composition book or planner of the present invention has three sections. In an alternate embodiment, the paper-based composition book or planner of the present invention has four sections. In an alternate embodiment, the paper-based composition book or planner of the present invention has five sections. In an alternate embodiment, the paper-based composition book or planner of the present invention has more than five sections.

### The Continuous Binding

The continuous binding of the paper-based composition book or planner of the present invention comprises a first outer cover hingedly connected to sequential inner covers that are located between the plurality of sections, via spines, and finally to a second outer cover.

When a paper-based composition book or planner of the present invention is viewed from above, the first outer cover is located on the bottom of the book or planner, and the second outer cover is located on the top of the book or planner. The sequential inner covers are located between the first and second outer covers. The covers are hingedly connected to spines via an edge of the cover. The covers may be hingedly connected to spines along any one of the edges. The choice of edge to which a spine may be hingedly connected to influences the combination of sections that may be accessed or displayed by the user.

The term “first edge” as used herein refers to the left-hand side edge of a cover when the paper-based composition book or planner of the present invention is closed and viewed from above.

The term “second edge” as used herein refers to the top edge of a cover when the paper-based composition book or planner of the present invention is closed and viewed from above.

The term “third edge” as used herein refers to the right-hand side edge of a cover when the paper-based composition book or planner of the present invention is closed and viewed from above.

The term “fourth edge” as used herein refers to the bottom edge of a cover when the paper-based composition book or planner of the present invention is closed and viewed from above.

In one embodiment, the present invention provides a paper-based composition book or planner comprising:
a. a first outer cover, having a first edge, a second edge, a third edge, and a fourth edge, wherein the first outer cover is hingedly connected to a first spine along the third edge of the of the first inner cover;
b. a first inner cover, having a first edge, a second edge, a third edge, and a fourth edge, wherein the first inner cover is hingedly connected to the first spine along the third edge of the first inner cover, wherein a first section comprising a plurality of pages is located between the first outer cover and the first inner cover, and wherein the first inner cover is hingedly connected to a second spine along the first edge of the first inner cover;
c. a second inner cover, having a first edge, a second edge, a third edge, and a fourth edge, wherein the second inner cover is hingedly connected to the second spine along the first edge of the second inner cover, and wherein the second inner cover is hingedly connected to a third spine along the second edge of the second inner cover; and
d. a second outer cover, having a first edge, a second edge, a third edge, and a fourth edge, wherein the second outer cover is hingedly connected to the third spine along the second edge of the second outer cover, and wherein a second section comprising a plurality of pages is located between the second outer cover and the second inner cover.

In one embodiment, the outer covers of the paper-based composition book or planner are held closed by a latch. In an alternate embodiment, the outer covers of the paper-based composition book or planner are held closed by a strap. In an alternate embodiment, the outer covers of the paper-based composition book or planner are held closed by an elastic band. In an alternate embodiment, the outer covers of the paper-based composition book or planner are held closed by a string.

In one embodiment, the present invention provides a paper-based composition book or planner comprising:
a. a first outer cover, having a first edge, a second edge, a third edge, and a fourth edge, wherein the first outer cover is hingedly connected to a first spine along the first edge of the first outer cover;
b. a first inner cover, having a first edge, a second edge, a third edge, and a fourth edge, wherein the first inner cover is hingedly connected to the first spine along the first edge of the first inner cover, and wherein a first section comprising a plurality of pages is located between the first outer cover and the first inner cover, and wherein the first inner cover is hingedly connected to a second spine along the second edge of the first inner cover;
c. a second inner cover, having a first edge, a second edge, a third edge, and a fourth edge, wherein the second inner cover is hingedly connected to the second spine along the second edge of the second inner cover, and wherein a second section comprising a plurality of pages is located between the first inner cover and the second inner cover, and wherein the second inner cover is hingedly connected to a third spine along the fourth edge of the second inner cover;
d. a third inner cover, having a first edge, a second edge, a third edge, and a fourth edge, wherein the third inner cover is hingedly connected to the third spine along the fourth edge of the third inner cover, and wherein a third section comprising a plurality of pages is located between the second inner cover and the third inner cover, and wherein the third inner cover is hingedly connected to a fourth spine along the third edge of the third inner cover; and
e. a second outer cover, having a first edge, a second edge, a third edge, and a fourth edge, wherein the second cover is hingedly connected to the fourth spine along the third edge of the third inner cover, and wherein a fourth section comprising a plurality of pages is located between the third inner cover and the second outer cover.

In one embodiment, the outer covers of the paper-based composition book or planner are held closed by a latch. In an alternate embodiment, the outer covers of the paper-based composition book or planner are held closed by a strap. In an alternate embodiment, the outer covers of the paper-based composition book or planner are held closed by an elastic band. In an alternate embodiment, the outer covers of the paper-based composition book or planner are held closed by a string.

While the covers for the paper-based composition book or planner of the present invention may be any shape, such as, for example, a square, rectangle, hexagon, and the like, in one embodiment, the shape of the covers for the paper-based composition book or planner of the present invention are selected from the group consisting of a square and a rectangle.

In the embodiments where the covers for the paper-based composition book or planner of the present invention are rectangular, the paper-based composition book or planner of the present invention may be used in a portrait orientation. Alternatively, the paper-based composition book or planner of the present invention may be used in a landscape orientation.

The continuous binding may be made from any material suitable of forming a bookbinding. One of ordinary skill in the art may readily select such materials. The factors influencing the selection may include, for example, the texture of the cover, the color of the cover, the thickness of the cover, the weight of the cover and the like.

The plurality of sections may be bound to the continuous binding by any suitable method. Such methods include, for example, case binding, oversewing, adhesive binding and the like.

### The Sections Comprising a Plurality of Pages

Without intending to limit the present invention in any way, an individual section of the plurality of sections comprising a plurality of pages that are located between the covers of the paper-based composition book or planner of the present invention may be configured to be any one of sections selected from the group consisting of a diary, a calendar, an address book, blank paper, lined paper, graph paper, a notebook, an almanac, a to-do-list, and a rolodex.

The pages may be made from any material suitable of forming a section of the present invention. One of ordinary skill in the art may readily select such materials. The factors influencing the selection may include, for example, the texture of the pages, the color of the pages, the thickness of the pages, the weight of the pages and the like.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

What is claimed is:

1. A paper-based composition book or planner comprising:
a. a first outer cover, having a first edge, a second edge, a third edge, and a fourth edge, wherein the first outer cover is hingedly connected to a first spine along the third edge of the of the first inner cover;
b. a first inner cover, having a first edge, a second edge, a third edge, and a fourth edge, wherein the first inner cover is hingedly connected to the first spine along the third edge of the first inner cover, wherein a first section comprising a plurality of pages is located between the first outer cover and the first inner cover, and wherein the first inner cover is hingedly connected to a second spine along the first edge of the first inner cover;
c. a second inner cover, having a first edge, a second edge, a third edge, and a fourth edge, wherein the second inner cover is hingedly connected to the second spine along the first edge of the second inner cover, and wherein the second inner cover is hingedly connected to a third spine along the second edge of the second inner cover; and
d. a second outer cover, having a first edge, a second edge, a third edge, and a fourth edge, wherein the second outer cover is hingedly connected to the third spine along the second edge of the second outer cover, and wherein a second section comprising a plurality of pages is located between the second outer cover and the second inner cover.

2. The paper-based composition book or planner of claim 1, wherein the one, or more than one of the sections may be accessed or displayed simultaneously.

3. A paper-based composition book or planner comprising:
a. a first outer cover, having a first edge, a second edge, a third edge, and a fourth edge, wherein the first outer cover is hingedly connected to a first spine along the first edge of the first outer cover;
b. a first inner cover, having a first edge, a second edge, a third edge, and a fourth edge, wherein the first inner cover is hingedly connected to the first spine along the first edge of the first inner cover, and wherein a first section comprising a plurality of pages is located between the first outer cover and the first inner cover, and wherein the first inner cover is hingedly connected to a second spine along the second edge of the first inner cover;
c. a second inner cover, having a first edge, a second edge, a third edge, and a fourth edge, wherein the second inner cover is hingedly connected to the second spine along the second edge of the second inner cover, and wherein a second section comprising a plurality of pages is located between the first inner cover and the second inner cover, and wherein the second inner cover is hingedly connected to a third spine along the fourth edge of the second inner cover;
d. a third inner cover, having a first edge, a second edge, a third edge, and a fourth edge, wherein the third inner cover is hingedly connected to the third spine along the fourth edge of the third inner cover, and wherein a third section comprising a plurality of pages is located between the second inner cover and the third inner cover, and wherein the third inner cover is hingedly connected to a fourth spine along the third edge of the third inner cover; and
e. a second outer cover, having a first edge, a second edge, a third edge, and a fourth edge, wherein the second cover is hingedly connected to the fourth spine along the third edge of the third inner cover, and wherein a fourth section comprising a plurality of pages is located between the third inner cover and the second outer cover.

4. The paper-based composition book or planner of claim 3, wherein the one, or more than one of the sections may be accessed or displayed simultaneously.
